(19) United States
(12) Patent Application Publication
(10) Pub. No.: US 2013/0024335 A1
(43) Pub. Date: Jan. 24, 2013

(54) SYSTEMS AND METHODS FOR HANDLING TRASH CONTAINING NON-RECYCLABLE SUBSTANCES

(71) Applicant: MAN LOK, Hong Kong (HK)

(72) Inventor: MAN LOK, Hong Kong (HK)

(21) Appl. No.: 13/185,820

(22) Filed: Jul. 19, 2011

(51) Int. Cl. G06Q 30/00

(52) U.S. Cl. 705/34

(57) ABSTRACT

Systems and methods are provided for handling trash containing non-recyclable substances. According to one embodiment, a system is provided for handling trash containing non-recyclable substances, poisonous substances, and human remains, for billing trash owners for billable trash items, and for crediting the trash owners for trash containing recyclable substances.

### FIELD OF THE INVENTION

The invention is generally related to methods and systems for handling trash containing non-recyclable substances. Specifically, and without limitation, this invention relates to using a trash collection device configured to collect trash bags. This invention further includes a smart card reader attached to the trash collection device for identifying identities of the trash owners, and a locator attached to the trash collection device for measuring distances between the trash collection device and trash disposal centers.

### BACKGROUND OF THE INVENTION

Trash management system is a pressing issue for many countries in the world. Specifically, the issue arises as to whether garbage disposal should be charged to the general public. And if it does, what should be the right system to assess the charges for trash disposed by the general public. There is a need to charge an individual or a company for garbage disposed, based on how much it costs to dispose a given amount of trash. The consideration, however, should be accounted in terms not just the amount of the trash, but also the nature of the trash and the location where the trash is thrown and where the trash is ultimately being processed. Thoughts should be given regarding the nature of trash when disposed. Currently, for encouraging environmental friendliness, trash cans are made available by the nature of the trash. For example, trash cans are made available for collecting cans, whereas dedicated trash bins are used for collecting glasses such as bottles. Ideally, such measures are seemingly workable. But they are not very effective. In reality, much of the trash is being thrown into trash box or bags with a mixture of materials. Some materials are recyclable, such as steel, glass, and plastic. Other materials may be less likely to be recyclable, including food remains, and other chemical compounds. Sometimes, the combined trash may contain substances that may be harmful to human beings, such as mercury, and other heavy metals. Therefore, there is a need to isolate the recyclable trash from the non-recyclable trash, and the poisonous garbage from the non-poisonous ones. Further, in some criminal cases, it has been reported that human bodies, such as bones, flesh, and other human remains are found in trash bags. For purposes of gathering forensic evidence for criminal prosecution, there is also strong need to have a system to identify such forensic evidence and trace back to the owners who attempt to make such disposal.

### SUMMARY OF THE INVENTION

A trash disposal system is provided for handling trash containing non-recyclable substances, poisonous substances, and human remains, for billing trash owners for billable trash items, and for crediting the trash owners for trash containing recyclable substances. Consistent with embodiments of the invention, the system comprises a trash collection device configured to collect trash bags; a smart card reader attached to the trash collection device for identifying identities of the trash owners; a locator attached to the trash collection device for measuring distances between the trash collection device and trash disposal centers; a first trash bag containing both recyclable substances and non-recyclable substances; a second trash bag containing both poisonous substances and non-poisonous substances.

In the embodiments, the poisonous substances may include mercury; a third trash bag containing human remains; a first RFID tag for tagging groupings of recyclable substances; a second RFID tag for tagging groupings of poisonous substances; a third RFID tag for tagging groupings of human remains; a first GPS device for locating groupings of recyclable substances; a second GPS device for locating groupings of poisonous substances; a third GPS device for locating groupings of human remains; a genetic identifier attached to the trash collection device for identifying human genomes; a poisonous identifier attached to the trash collection device for identifying the poisonous substances; a bill payment calculating device for billing the trash owners for the billable trash items, and crediting the trash owners for the trash containing recyclable substances; a processor; and a memory containing instructions that cause the processor to execute a method.

In one embodiment, the method may comprise identifying a trash owner using the smart card reader; collecting the first trash bag from the trash owner into the trash collection device; identifying the recyclable substances in the first trash bag separating, from the first trash bag, the recyclable substances from the non-recyclable substances into a recyclable grouping handling the recyclable substances and a non-recyclable grouping handling the non-recyclable substances; calculating costs of processing the non-recyclable substances using the bill payment calculating device and the locator, based on location distance between a trash disposal center processing the non-recyclable substance and the trash collection device; calculating a credit return to the trash owner using the bill payment calculating device, based on amount and nature of the recyclable substances; generating a debit amount to the trash owner, based on the calculated costs of processing the non-recyclable substances and the calculated credit return; delivering the non-recyclable substances to the trash disposal center processing the non-recyclable substance; and delivering the recyclable substances to the trash disposal center processing the recyclable substance.

In another embodiment, the method may comprise identifying a trash owner using the smart card reader; collecting the second trash bag from the trash owner into the trash collection device; identifying the poisonous substances in the second trash bag using the poisonous identifier; separating, from the second trash bag, the poisonous substances from the non-poisonous substances into a poisonous grouping handling the poisonous substances and a non-poisonous grouping handling the non-poisonous substances; calculating costs of processing the non-poisonous substances using the bill payment calculating device and the locator, based on location distance between a trash disposal center processing the non-poisonous substance and the trash collection device; calculating a credit return to the trash owner using the bill payment calculating device, based on amount and nature of the poisonous substances; generating a debit amount to the trash owner, based on the calculated costs of processing the non-poisonous substances and the calculated credit return; storing a sample representing the poisonous substances; tagging the sample with the second RFID tag; associating the second RFID tag with the trash owner to associate the poisonous substances with an identity of the trash owner; associating the sample with the second GPS device for locating the poisonous substances; delivering the sample to the trash disposal center processing the poisonous substance; delivering the non-poisonous substances to the trash disposal center processing the non-poisonous substance; delivering the poisonous substances to the trash disposal center processing the poisonous substance; and tracking the delivery of the poisonous substances and the sample by using the second RFID tag and the second GPS device.

Further, the embodied method may comprise identifying a trash owner using the smart card reader; collecting the third trash bag from the trash owner into the trash collection device; identifying the human remains in the third trash bag using the genetic identifier; separating, from the third trash bag, the human remains from rest of substances in the third trash bag; calculating costs of processing the rest of substances using the bill payment calculating device and the locator, based on location distance between a trash disposal center processing the rest of substances and the trash collection device; calculating costs of processing the human remains using the bill payment calculating device and the locator, based on location distance between a trash disposal center processing the human remains and the trash collection device; storing a sample representing the human remains, including the human genomes; tagging the sample with the third RFID tag; associating the third RFID tag with the trash owner to associate the human remains with an identity of the trash owner; associating the sample with the third GPS device for locating the human remains; delivering the sample to the trash disposal center processing the human remains; delivering the human remains to the trash disposal center processing the human remains; and tracking the delivery of the human remains and the sample by using the third RFID tag and the third GPS device.

### BRIEF DESCRIPTION OF THE DRAWINGS

FIG. 1 illustrates an exemplary system to handle waste properly, consistent with embodiments of the invention.

### DETAILED DESCRIPTION

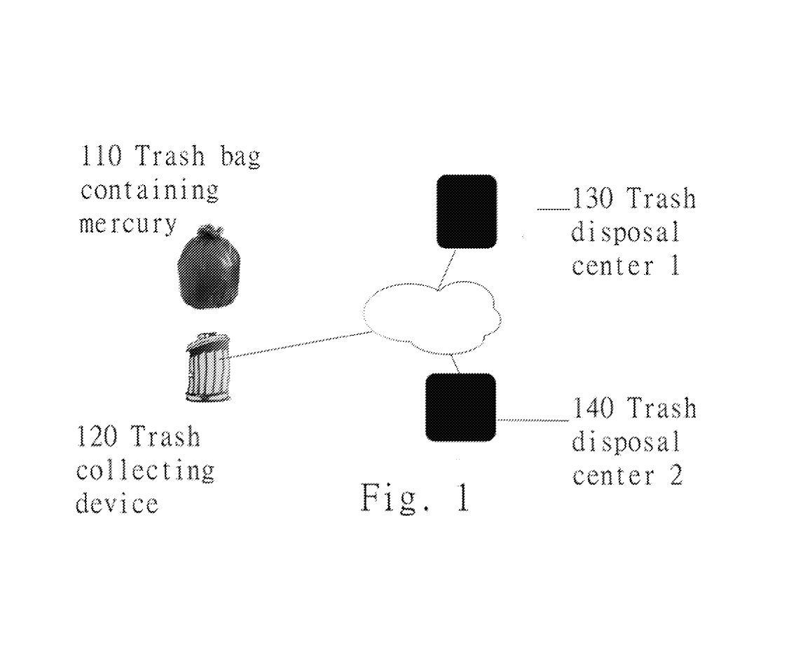

A trash disposal system for handling trash is disclosed. In FIG. 1, a trash disposal system discloses a system containing non-recyclable substances, poisonous substances, and human remains, for billing trash owners for billable trash items, and for crediting the trash owners for trash containing recyclable substances, comprising a trash collection device (120) configured to collect trash bags; a smart card reader attached to the trash collection device (120) for identifying identities of the trash owners; a locator attached to the trash collection device (120) for measuring distances between the trash collection device (120) and trash disposal centers (130); a first trash bag (110) containing both recyclable substances and non-recyclable substances; a second trash bag (110) containing both poisonous substances and non-poisonous substances, wherein the poisonous substances including mercury; a third trash bag (110) containing human remains; a first RFID tag for tagging groupings of recyclable substances; a second RFID tag for tagging groupings of poisonous substances; a third RFID tag for tagging groupings of human remains; a first GPS device for locating groupings of recyclable substances; a second GPS device for locating groupings of poisonous substances; a third GPS device for locating groupings of human remains; a genetic identifier attached to the trash collection device (120) for identifying human genomes; a poisonous identifier attached to the trash collection device (120) for identifying the poisonous substances; a bill payment calculating device for billing the trash owners for the billable trash items, and crediting the trash owners for the trash containing recyclable substances; a processor; a memory containing instructions that cause the processor to execute a method, the method comprising identifying a trash owner using the smart card reader; collecting the first trash bag (110) from the trash owner into the trash collection device (120); identifying the recyclable substances in the first trash bag (110) separating, from the first trash bag the recyclable substances from the non-recyclable substances into a recyclable grouping handling the recyclable substances and a non-recyclable grouping handling the non-recyclable substances; calculating costs of processing the non-recyclable substances using the bill payment calculating device and the locator, based on location distance between a trash disposal center (140) processing the non-recyclable substance and the trash collection device (120); calculating a credit return to the trash owner using the bill payment calculating device, based on amount and nature of the recyclable substances; generating a debit amount to the trash owner, based on the calculated costs of processing the non-recyclable substances and the calculated credit return; delivering the non-recyclable substances to the trash disposal center (140) processing the non-recyclable substance; and delivering the recyclable substances to the trash disposal center (140) processing the recyclable substance.

In another implementation, a trash disposal system for handling trash is disclosed. Such a system contains non-recyclable substances, poisonous substances, and human remains, for billing trash owners for billable trash items, and for crediting the trash owners for trash containing recyclable substances, comprising a trash collection device (120) configured to collect trash bags; a smart card reader attached to the trash collection device (120) for identifying identities of the trash owners; a locator attached to the trash collection device (120) for measuring distances between the trash collection device (120) and trash disposal centers; a first trash bag (110) containing both recyclable substances and non-recyclable substances; a second trash bag (110) containing both poisonous substances and non-poisonous substances, wherein the poisonous substances including mercury; a third trash bag (110) containing human remains; a first RFID tag for tagging groupings of recyclable substances; and a second RFID tag for tagging groupings of poisonous substances.

Further, in this implementation, another RFID tag is provided. The tag is used for tagging groupings of human remains. Other components may be include, including a first GPS device for locating groupings of recyclable substances; a second GPS device for locating groupings of poisonous substances; a third GPS device for locating groupings of human remains; a genetic identifier attached to the trash collection device (120) for identifying human genomes; a poisonous identifier attached to the trash collection device (120) for identifying the poisonous substances; a bill payment calculating device for billing the trash owners for the billable trash items, and crediting the trash owners for the trash containing recyclable substances; a processor; a memory containing instructions that cause the processor to execute a method, the method comprising identifying a trash owner using the smart card reader; collecting the second trash bag (110) from the trash owner into the trash collection device (120); identifying the poisonous substances in the second trash bag (110) using the poisonous identifier; separating, from the second trash bag, the poisonous substances from the non-poisonous substances into a poisonous grouping handling the poisonous substances and a non-poisonous grouping handling the non-poisonous substances; calculating costs of processing the non-poisonous substances using the bill payment calculating device and the locator, based on location distance between a trash disposal center processing the non-poisonous substance and the trash collection device (120); calculating a credit return to the trash owner using the bill payment calculating device, based on amount and nature of the poisonous substances; generating a debit amount to the trash owner, based on the calculated costs of processing the non-poisonous substances and the calculated credit return; storing a sample representing the poisonous substances; tagging the sample with the second RFID tag; associating the second RFID tag with the trash owner to associate the poisonous substances with an identity of the trash owner; associating the sample with the second GPS device for locating the poisonous substances; delivering the sample to the trash disposal center processing the poisonous substance; delivering the non-poisonous substances to the trash disposal center processing the non-poisonous substance; delivering the poisonous substances to the trash disposal center processing the poisonous substance; and tracking the delivery of the poisonous substances and the sample by using the second RFID tag and the second GPS device.

In one aspect of the invention, a trash collection device (120) configured to collect trash bags is included. Other components are included, including a smart card reader attached to the trash collection device (120) for identifying identities of the trash owners; a locator attached to the trash collection device (120) for measuring distances between the trash collection device (120) and trash disposal centers; a first trash bag (110) containing both recyclable substances and non-recyclable substances; a second trash bag (110) containing both poisonous substances and non-poisonous substances, wherein the poisonous substances including mercury; a third trash bag (110) containing human remains; a first RFID tag for tagging groupings of recyclable substances; a second RFID tag for tagging groupings of poisonous substances; a third RFID tag for tagging groupings of human remains; a first GPS device for locating groupings of recyclable substances; a second GPS device for locating groupings of poisonous substances; a third GPS device for locating groupings of human remains; a genetic identifier attached to the trash collection device (120) for identifying human genomes; a poisonous identifier attached to the trash collection device (120) for identifying the poisonous substances; a bill payment calculating device for billing the trash owners for the billable trash items, and crediting the trash owners for the trash containing recyclable substances; a processor; a memory containing instructions that cause the processor to execute a method, the method comprising identifying a trash owner using the smart card reader; collecting the third trash bag (110) from the trash owner into the trash collection device (120); identifying the human remains in the third trash bag (110) using the genetic identifier; separating, from the third trash bag, the human remains from rest of substances in the third trash bag; calculating costs of processing the rest of substances using the bill payment calculating device and the locator, based on location distance between a trash disposal center processing the rest of substances and the trash collection device (120); calculating costs of processing the human remains using the bill payment calculating device and the locator, based on location distance between a trash disposal center processing the human remains and the trash collection device (120); storing a sample representing the human remains, including the human genomes; tagging the sample with the third RFID tag; associating the third RFID tag with the trash owner to associate the human remains with an identity of the trash owner; associating the sample with the third GPS device for locating the human remains; delivering the sample to the trash disposal center processing the human remains; delivering the human remains to the trash disposal center processing the human remains; and tracking the delivery of the human remains and the sample by using the third RFID tag and the third GPS device.

What is claimed is:

1. A trash disposal system for handling trash containing non-recyclable substances, poisonous substances, and human remains, for billing trash owners for billable trash items, and for crediting the trash owners for trash containing recyclable substances, comprising:
a trash collection device configured to collect trash bags;
a smart card reader attached to the trash collection device for identifying identities of the trash owners;
a locator attached to the trash collection device for measuring distances between the trash collection device and trash disposal centers;
a first trash bag containing both recyclable substances and non-recyclable substances;
a second trash bag containing both poisonous substances and non-poisonous substances, wherein the poisonous substances including mercury;
a third trash bag containing human remains;
a first RFID tag for tagging groupings of recyclable substances;
a second RFID tag for tagging groupings of poisonous substances;
a third RFID tag for tagging groupings of human remains;
a first GPS device for locating groupings of recyclable substances;
a second GPS device for locating groupings of poisonous substances;
a third GPS device for locating groupings of human remains;
a genetic identifier attached to the trash collection device for identifying human genomes;
a poisonous identifier attached to the trash collection device for identifying the poisonous substances;
a bill payment calculating device for billing the trash owners for the billable trash items, and crediting the trash owners for the trash containing recyclable substances;
a processor; and
a memory containing instructions that cause the processor to execute a method.

2. The trash disposal system of claim 1, wherein the method comprises:
identifying a trash owner using the smart card reader;
collecting the first trash bag from the trash owner into the trash collection device;
identifying the recyclable substances in the first trash bag
separating, from the first trash bag, the recyclable substances from the non-recyclable substances into a recyclable grouping handling the recyclable substances and a non-recyclable grouping handling the non-recyclable substances;
calculating costs of processing the non-recyclable substances using the bill payment calculating device and the locator, based on location distance between a trash disposal center processing the non-recyclable substance and the trash collection device;
calculating a credit return to the trash owner using the bill payment calculating device, based on amount and nature of the recyclable substances;
generating a debit amount to the trash owner, based on the calculated costs of processing the non-recyclable substances and the calculated credit return;
delivering the non-recyclable substances to the trash disposal center processing the non-recyclable substance; and
delivering the recyclable substances to the trash disposal center processing the recyclable substance.

3. The trash disposal system of claim 1, wherein the method comprises:
identifying a trash owner using the smart card reader;
collecting the second trash bag from the trash owner into the trash collection device;
identifying the poisonous substances in the second trash bag using the poisonous identifier;
separating, from the second trash bag, the poisonous substances from the non-poisonous substances into a poisonous grouping handling the poisonous substances and a non-poisonous grouping handling the non-poisonous substances;
calculating costs of processing the non-poisonous substances using the bill payment calculating device and the locator, based on location distance between a trash disposal center processing the non-poisonous substance and the trash collection device;
calculating a credit return to the trash owner using the bill payment calculating device, based on amount and nature of the poisonous substances;
generating a debit amount to the trash owner, based on the calculated costs of processing the non-poisonous substances and the calculated credit return;
storing a sample representing the poisonous substances;
tagging the sample with the second RFID tag;
associating the second RFID tag with the trash owner to associate the poisonous substances with an identity of the trash owner;
associating the sample with the second GPS device for locating the poisonous substances;
delivering the sample to the trash disposal center processing the poisonous substance;
delivering the non-poisonous substances to the trash disposal center processing the non-poisonous substance;
delivering the poisonous substances to the trash disposal center processing the poisonous substance; and
tracking the delivery of the poisonous substances and the sample by using the second RFID tag and the second GPS device.

4. The trash disposal system of claim 1, wherein the method comprises:
identifying a trash owner using the smart card reader;
collecting the third trash bag from the trash owner into the trash collection device;
identifying the human remains in the third trash bag using the genetic identifier;
separating, from the third trash bag, the human remains from rest of substances in the third trash bag;
calculating costs of processing the rest of substances using the bill payment calculating device and the locator, based on location distance between a trash disposal center processing the rest of substances and the trash collection device;
calculating costs of processing the human remains using the bill payment calculating device and the locator, based on location distance between a trash disposal center processing the human remains and the trash collection device;
storing a sample representing the human remains, including the human genomes;
tagging the sample with the third RFID tag;
associating the third RHO tag with the trash owner to associate the human remains with an identity of the trash owner;
associating the sample with the third GPS device for locating the human remains;
delivering the sample to the trash disposal center processing the human remains;
delivering the human remains to the trash disposal center processing the human remains; and
tracking the delivery of the human remains and the sample by using the third RFID tag and the third GPS device.
